(19) United States
(12) Patent Application Publication
(10) Pub. No.: US 2024/0220473 A1
(43) Pub. Date: Jul. 4, 2024

(54) OPTIMAL REORGANIZATION OF A DATABASE

(71) Applicant: BMC Software, Inc., Houston, TX (US)

(72) Inventors: Anshul Agrawal, Pune (IN); Steven Lee Stewart, Columbus, GA (US)

(21) Appl. No.: 18/147,937

(22) Filed: Dec. 29, 2022

(51) Int. Cl. G06F 16/22

(52) U.S. Cl. CPC G06F 16/2272

(57) ABSTRACT

Described systems and techniques enable a database reorganization process to run to completion in an automated mode by dynamically and efficiently allocating buffer space and by automatically bypassing units of work (UOWs) that house larger database records whose requirements exceed the allocated or obtainable amount of buffer space. An amount of space allocated to UOWs in an overflow part of the area of the database is determined. A number of buffers required to reorganize the UOWs is determined. Selection criteria is set based on the number of buffers or a keyword command. The area of the database is reorganized using the selection criteria including bypassing the UOWs that do not meet the selection criteria.

### TECHNICAL FIELD

This description relates to systems and techniques for optimizing the reorganization of a database. More specifically, the description relates to systems and techniques for optimizing the reorganization of a Fast Path database such as, for example, the reorganization of a data entry database (DEDB) area.

### BACKGROUND

In general, databases that process large volumes of data may require frequent reorganization because of high transaction activity. For example, the IBMR Information Management System (IMS™) is a message-based transaction manager and hierarchical-database manager for databases. One type of IMS database is a Fast Path database such as, for example, a DEDB. Fast Path data entry databases (DEDBs) provide superior transaction throughput, manageability, large data volume capacity, and speed. DEDBs process large volumes of data with a transaction rate higher than any other type of mainframe database; therefore, they require frequent reorganization because of high transaction activity. The speed and volatility of digital business demand that the DEDB areas need to be reorganized to meet application demands require an outage to reorganize. However, even planned outages are disruptive. Therefore, it is desirable to reorganize DEDB areas to improve performance and to deal with space issues, while at the same time, keeping the DEDB areas and applications online and available continuously.

### SUMMARY

Described systems and techniques enable a reorganization process for a database to run to completion in an automated mode by efficiently allocating buffer space and by automatically bypassing units of work (UOWs) that house larger database records whose requirements exceed the allocated or obtainable amount of buffer space. According to some general aspects, a computer program product may be tangibly embodied on a non-transitory computer-readable storage medium and may include instructions. When executed by at least one computing device, the instructions may cause the at least one computing device to determine an amount of space allocated to UOWs in an overflow part of the area of the database. A number of buffers required to reorganize the UOWs is determined. Selection criteria is set based on the number of buffers. The area of the database is reorganized using the selection criteria including bypassing the UOWs that do not meet the selection criteria.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

According to some general aspects, a computer program product may be tangibly embodied on a non-transitory computer-readable storage medium and may include instructions. When executed by at least one computing device, the instructions may cause the at least one computing device to traverse space maps of control intervals (CIs) for an overflow part of the area of the database and, for each UOW from a plurality of UOWs stored in the area of the database, determine which of the CIs are allocated to each of the plurality of UOWs from the space maps. One UOW from the plurality of UOWs is identified that uses a highest number of the CIs in the overflow part and a number of buffers required to reorganize the one UOW is determined. Selection criteria is set based on the number of buffers. The area of the database is reorganized using the selection criteria including bypassing UOWs from the plurality of UOWs that do not meet the selection criteria.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a database system.

FIG. 2 is a block diagram of an area of a database.

FIG. 3 is a flowchart illustrating example operations of the system of FIG. 1.

FIG. 4 is a flowchart illustrating example operations of the system of FIG. 1.

### DETAILED DESCRIPTION

Described systems and techniques enable the reorganization of a database or database areas while the database remains online and available by solving technical problems associated with conditions of the database that may cause the reorganization to fail. The reorganization of the database or database areas eliminates unusable fragmented free space elements and enables those free space elements within the database to be reclaimed and reused. For example, a reorganization utility may interface with the database to enable reorganization of the entire database or parts of the database without an outage. That is, the database remains online and available for use while the fragmented free space elements are reclaimed.

During the reorganization process, which may also be referred to as a reorganization function, certain database conditions may be encountered that cause the reorganization to fail and/or become inefficient. For example, one database condition occurs when a large database record (or records) results in requiring more buffer space for the reorganization than can be allocated or acquired. This database condition is a technical problem during the reorganization process that causes the reorganization to fail. Specifically, the reorganization fails because not enough buffer space can be obtained to reorganize an associated UOW, which causes the reorganization process to fail in its entirety. The effects of the technical problem include the failure of the reorganization process, increased input/output cycles and central processing unit (CPU) cycles, and potential outage of the database to manually troubleshoot the database condition that caused the failure.

Described systems and techniques solve this technical problem and other related technical problems that may be encountered during the reorganization process. Specifically, the described technical solutions enable the reorganization process to run to completion in an automated mode or automated manner by efficiently allocating buffer space and by automatically bypassing UOWs that house larger database records whose requirements exceed the allocated or obtainable amount of buffer space. The technical solutions solve the database conditions that cause the reorganization process to fail in its entirety and avoid the manual intervention that would be required to fix the reorganization process that failed.

More specifically, the described technical solutions traverse a mapping of an overflow area of the database associated with the database records that are being reorganized. Traversing the mapping identifies the UOW that uses the largest amount of overflow area of the database. The number of buffers needed to reorganize the identified database record is calculated and is used as a parameter or parameter factor in the selection criteria that determines which database records are to be included in the reorganization process and which database records are not to be included in the reorganization process. In this manner, the selection criteria is dynamically generated to automatically exclude database records from the reorganization process that would otherwise cause the reorganization process to fail.

The described technical solutions improve the reorganization process by preventing the process from failing due to certain database conditions such as, for example, the database condition described above. The described technical solutions determine the selection criteria by traversing the mapping of only a portion of the database area being reorganized without having to traverse the mapping of the entire area. The dynamically generated selection criteria used during the reorganization process avoids any manual calculations or manual intervention during the reorganization process. For database records that do not meet the selection criteria and are not included in the reorganization process, a message is generated to provide an indication that processing has been bypassed for those database records. The described technical solutions enable the database to remain online and available during the reorganization process. In this manner, database outages may be avoided.

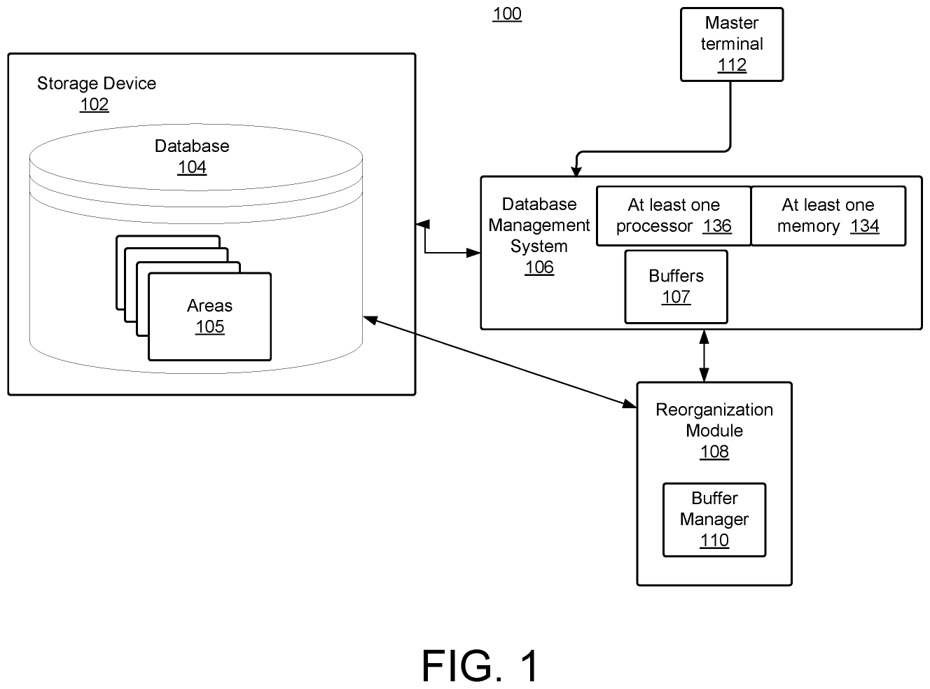

FIG. 1 is an example block diagram of a database system 100. The database system 100 includes a storage device 102 that is configured to store a database 104, a database management system 106, and a reorganization module 108. A master terminal 112 having a display and user interface may be used to interface and interact with the database management system 106. The storage device 102 may include any type of storage device capable of storing the database 104 including, but not limited to, a disk-based storage device and a memory-based storage device. The database 104 may include an IMS database. One type of IMS database includes a Fast Path database. Fast Path databases include DEDBs and main storage databases (MSDBs). DEDBs provide efficient storage for and access to large volumes of data. DEDBs also provide a high-level of availability to that data. MSDBs store and provide access to a database's most frequently used data. The database 104 may include one or more areas 105, as discussed in more detail below.

The storage device 102 and the database 104 may be communicatively coupled to the database management system 106. IMS is one example of the database management system 106. IMS is a hierarchical database management software system for online transaction processing (OLTP) and online batch processing that may process thousands, millions, billions, and up to trillions of transactions over a period of time (e.g., over a day, week, etc.). IMS is used in many different industries including, for example, banking and finance, travel, healthcare, telecommunication, automotive, retail, manufacturing, oil and gas, energy, as well as other industries. IMS manages, schedules, and performs OLTP for applications that access IMS data as well as data stored in the database 104. The database management system 106, including IMS, manages all aspects of the database 104 including management of the database structure, organization of the database structure, transaction management, database record keeping, and the like.

The database management system 106 includes buffers 107. The buffers 107 (also referred to as buffer pools) are temporary free space or temporary storage used to support various aspects of database management performed by the database management system 106. For example, the buffers 107 are used during the reorganization process by the reorganization module 108.

The database management system 106 may be implemented on a computing device that includes at least one memory 134 and at least one processor 136. The at least one processor 136 may represent two or more processors executing in parallel and utilizing corresponding instructions stored using the at least one memory 134. The at least one processor 136 may include at least one CPU. The at least one memory 134 represents a non-transitory computer-readable storage medium. Of course, similarly, the at least one memory 134 may represent one or more different types of memory utilized by the database system 100. In addition to storing instructions, which allow the at least one processor 136 to implement the database management system 106 and the reorganization module 108 and other various components, the at least one memory 134 may be used to store data and other information used by and/or generated by the database management system 106 and the reorganization module 108.

The reorganization module 108 is communicatively coupled with the database 104 and the database management system 106. The reorganization module 108 is configured to reorganize the database 104 or at least reorganize one or more of the areas 105 of the database 104 when free space elements (FSEs) in the areas 105 become fragmented. The reorganization module 108 may function as a plug-in utility tool or plug-in module to the database management system 106. The reorganization module 108 includes a buffer manager 110 that is configured to manage the buffers 107 usage during the reorganization process.

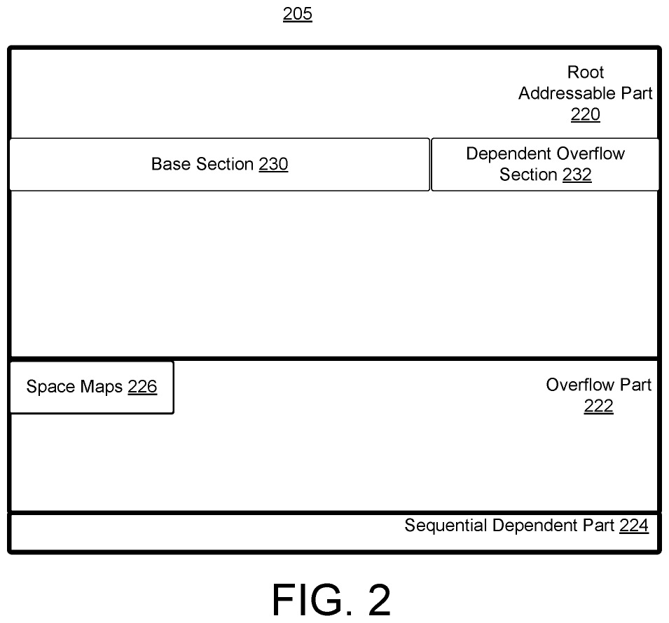

In one example, the database 104 is a DEDB that includes multiple areas 105. The reorganization module 108 is configured to reorganize one or more of the areas 105. Referring to FIG. 2, an example DEDB area 205 is illustrated. The DEDB area 205 is an example of one area of the multiple areas 105 of FIG. 1. The DEDB area 205 includes a root addressable part 220, an overflow part 222 (also referred to interchangeably as an independent overflow part (IOVF)), and a sequential dependent part 224.

The root addressable part 220 is divided into UOWs, which are the basic elements of space allocation. A UOW consists of a user-specified number of CIs located physically contiguous to one another. Each UOW in the root addressable part 220 is further divided into a base section 230 and a dependent overflow section 232. The base section 230 contains CIs of the UOW that are addressed by a randomizing module, whereas the dependent overflow section 232 of the UOW is used as a logical extension of a CI within that UOW. Root and direct dependent segments are stored in the base section 230. Both can be stored in the dependent overflow section 232 if the base section 230 is full.

The overflow part 222 contains empty CIs that can be used by any UOW in the DEDB area 205. However, when the UOW gets a CI that is in the overflow part 222, the CI can be used only by that UOW and is considered an independent overflow CI. A CI in the overflow part 222 can be considered an extension of the dependent overflow section 232 in the root addressable part 220 as soon as it is allocated to any UOW. The independent overflow CI remains allocated to a specific UOW unless, after a reorganization, it is no longer required, at which time it is freed to be used by other of the UOWs.

The sequential dependent part 224 holds sequential dependent segments from roots in all UOWs in the area. Sequential dependent segments are stored in chronological order without regard to the root or UOW that contains the root. When the sequential dependent part 224 is full, it is reused from the beginning. However, before the sequential dependent part 224 can be reused, a contiguous segment or all of the sequential dependent segments in that part must be deleted.

The overflow part 222 includes space maps 226. The space maps 226 map the details of the overflow part 222 including the UOWs occupying CIs in the overflow part 222. The first CI in the overflow part 222 of the DEDB area 205 contains a space map (also referred to as a SMAP) from the space maps 226. There is a space map for every 120 CIs in overflow part 222 (i.e., the 1^{st}, 121^{st}, 241^{st}, etc. CIs in the overflow part 222 are space map CIs). The space map occupies the first CI in each group of 120 CIs and the space map indicates which UOWs “own” the following 119 CIs in the overflow part 222. The space maps 226 keep track of free space and UOW ownership of CIs in overflow part 222 in the DEDB area 205.

When database records are such that they are huge and span across CIs such that, for example, more than 32,768 (32 K) CIs in overflow part 222 are associated with a single UOW (e.g., due to for example, long twin chains, randomization inefficiency, etc.), then this database condition will cause the reorganization process performed by the reorganization module 108 to fail since this task requires more than the maximum number of buffers 107 that can be allocated when using the buffer manager 110, when the buffer manager 110 is a 31-bit buffer manager.

Referring back to FIG. 1, the reorganization module 108 is configured to perform a reorganization process with a technical solution implemented to solve the technical problems related to the above-discussed database conditions that cause the reorganization process to fail. Specifically, selection criteria is dynamically determined and inserted into the reorganization process to enable the process to run to completion by efficiently allocating the required number of buffers 107 to the overflow part 222 and by automatically bypassing UOWs using more than for example, 32 K CIs in overflow part 222.

Specifically, the reorganization module 108 performs the reorganization process in conjunction with the buffer manager 110 while the database 104 and the areas 105 remain online and available. Before initiating the reorganization process, the reorganization module 108 is configured to determine an amount of space allocated to UOWs in the overflow part 222 of the DEDB area 205 of the database 104. The reorganization module 108 determines a number of buffers 107 needed to reorganize the UOWs. The reorganization module 108 sets selection criteria based on the number of buffers 107 and reorganizes the DEDB area 205 of the database 104 using the selection criteria including bypassing the UOWs that do not meet the selection criteria. In this manner, the selection criteria is optimized based on the characteristics of the data in the DEDB area 205 being reorganized. The number of CIs in the overflow part 222 being used by each UOW is pre-determined by examining the information in the space maps 226, which correspond to the CIs in the overflow part 222, upfront rather than by reading the entire area. That is, the space maps 226 are read only for the overflow part 222 and not for the rest of the DEDB area 205. The selection criteria are dynamically set based on traversing and reading the space maps 226.

As mentioned above, the reorganization module 108 traverses through the space maps 226 which correspond to CIs in overflow part 222 that are associated with the UOWs being reorganized. Once the UOW in the DEDB area 205 that uses the most CIs in overflow part 222 is less than a threshold value (e.g., less than 32 K) is identified, the number of buffers needed to reorganize this UOW, and therefore all other UOWs in the DEDB area 205, is calculated and then used when dynamically adding a “SELECT_UOW=(IOVF,,n2)” keyword to the reorganize process.

Stated in a more detailed manner, the reorganization module 108 is configured to traverse the space maps 226 of CIs in the overflow part 222 of the DEDB area 205 of the database 104. For each UOW stored in the DEDB area 205, the reorganization module 108 determines which of the CIs are allocated to each of the UOWs from the space maps 226. The reorganization module 108 identifies one UOW that uses the highest number of CIs in the overflow part 222 that is less than the threshold value (e.g., less than 32 K) and determines the number of buffers 107 needed to reorganize records in that one UOW. The reorganization module 108 sets selection criteria based on the number of buffers 107 for that one UOW. Then, the reorganization module 108 reorganizes the DEDB area 205 using the selection criteria including bypassing UOWs that do not meet the selection criteria.

The reorganization module 108 may perform the reorganization process for all of the areas 105 at once. For example, the reorganization module 108 starts from a first area and reads all the space maps 226 into storage such as, for example, the at least one memory 134. For instance, there is only one space map for every 120 CIs in the overflow part 222. Then, for each UOW, the reorganization module 108 determines which CIs in the overflow part 222 are allocated to which UOW. There is one entry in a chain of UOWs for a count of CIs in the overflow part 222 that are in use. Once all the space maps are read and counts are increased for the CIs in the overflow part 222 in use by each UOW, the reorganization module 108 determines a list with all UOWs and number of CIs in the overflow part 222 that each UOW uses. The reorganization module 108 traverses through the chain of UOWs and determines the one UOW that has the most CIs in the overflow part 222 that is less than the threshold value (e.g., less than 32 K).

For example, if within the same DEDB area 205, UOW #199 “owns” 70K CIs in the overflow part 222 and UOW #440 “owns” 10K CIs in the overflow part 222, then the reorganization module 108 will allocate 10K plus an additional 10% more CIs (i.e., 11 K) to overflow part 222 buffers 107 that will be sufficient for all of the CIs in use except for UOW #199. The additional 10% is added to allow for potential concurrent online updates. The reorganization module 108 sets the selection criteria to 11K. In some implementations, a keyword command is used such as, for example, “SELECT_UOW=(IOVF, 11000)” to assist with setting the selection criteria. Such a keyword command causes the reorganization process to skip the reorganization of UOW #199 because of its 70 K CI size and continue with the reorganization of all other UOWs without causing any issues. In this manner, the appropriate buffer space is allocated for all of the UOWs that may be less than 32 K.

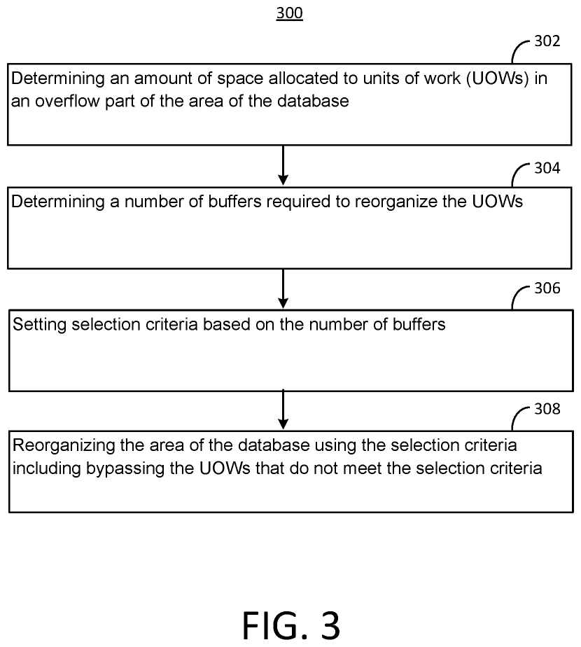

FIG. 3 is an example flow diagram of a process 300 for reorganizing an area of a database using the database system 100 of FIG. 1. Process 300 is a computer-implemented method that may be implemented by the reorganization module 108 and its related components, including the buffer manager 110. Instructions and/or executable code for the performance of process 300 may be stored in the at least one memory 134, and the stored instructions may be executed by the at least one processor 136. Process 300 is also illustrative of a computer program product that may be implemented by the reorganization module 108.

Process 300 includes determining an amount of space allocated to units of work (UOWs) in an overflow part of the area of the database (302). For example, the reorganization module 108 determines an amount of space allocated to UOWs in the overflow part 222 of the DEDB area 205. In some implementations, the reorganization module 108 determines the amount of space allocated to UOWs in the overflow part 222 by traversing the space maps 226 for the overflow part 222. The reorganization module 108 may traverse the space maps for the overflow part 222 without reading the DEDB area 205 in its entirety.

Process 300 includes determining a number of buffers required to reorganize the UOWs (304). For example, once all the space maps 226 have been traversed and read, the reorganization module 108 determines the number of buffers 107 required to reorganize the UOWs. In some implementations, the reorganization module 108 determines the number of buffers 107 needed by finding the UOW that uses a highest number of CIs in the overflow part 222 that is less than the threshold value (e.g., 32 K). The reorganization module 108 may find this UOW by counting the number of CIs in the overflow part 222 allocated to each UOW. The UOW with the most CIs allocated to it is selected and that number of buffers 107 required to reorganize the UOWs is set to this number.

Process 300 includes setting selection criteria based on the number of buffers (306). For example, the reorganization module 108 sets the selection criteria based on the number of buffers 107 determined above. The selection criteria may include the number of buffers plus an additional margin (e.g., an additional 10%).

Process 300 includes reorganizing the area of the database using the selection criteria including bypassing the UOWs that do not meet the selection criteria (308). For example, the reorganization module 108 reorganizes the DEDB area 205 using the selection criteria including bypassing the UOWs that do not meet the selection criteria. In some implementations, the selection criteria include a keyword command to bypass the UOWs that exceed the threshold value for the overflow part 222. The keyword command may be inserted into a reorganization process without manual intervention for reorganizing the DEDB area 205. In some implementations, the largest value allowed as part of the selection criteria may be 32,768.

For instance, in one example, a largest UOW in an area being reorganized may include 36,000 CIs in the overflow part 222 and the next largest UOW in the area uses 8,000 CIs in the overflow part 222. In this case, the selection criteria may be a keyword command with the buffer amount needed to reorganize the area set to 8,800 CIs, which is 8,000 plus 10%. Any UOW having greater than 8,800 CIs is bypassed. In this case, the UOW having 36,000 CIs in the overflow part is bypassed and not included in the reorganization process and the reorganization process runs to completion without failing.

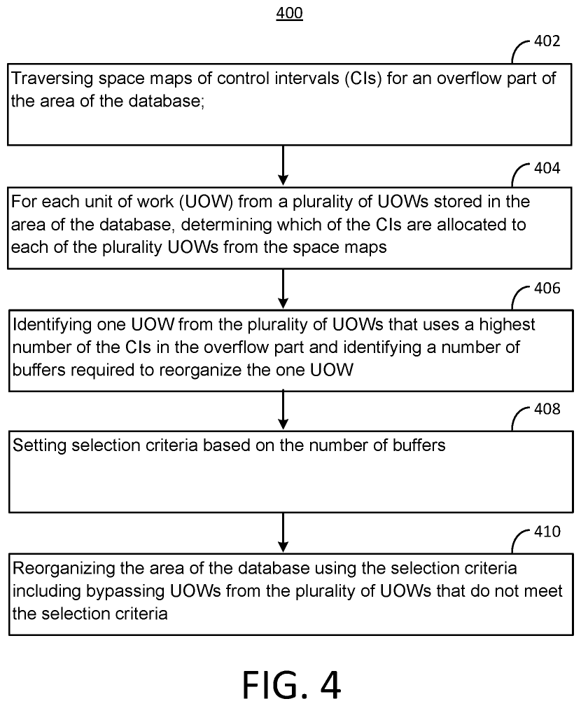

FIG. 4 is an example flow diagram of a process 400 for reorganizing an area of a database 104 using the database system 100 of FIG. 1. Process 400 is a computer-implemented method that may be implemented by the reorganization module 108 and its related components, including the buffer manager 110. Instructions and/or executable code for the performance of process 400 may be stored in the at least one memory 134, and the stored instructions may be executed by the at least one processor 136. Process 400 is also illustrative of a computer program product that may be implemented by the reorganization module 108.

Process 400 includes traversing space maps of control intervals (CIs) for an overflow part of the area of the database (402). For example, the reorganization module 108 traverses the space maps 226 of CIs in the overflow part 222 of the DEDB area 205.

Process 400 includes, for each unit of work (UOW) from a plurality of UOWs stored in the area of the database, determining which of the CIs are allocated to each of the plurality UOWs from the space maps (404). For example, the reorganization module 108 uses the space maps 226 to determine which of the CIs are allocated to each UOW.

Process 400 includes identifying one UOW from the plurality of UOWs that uses a highest number of the CIs in the overflow part and identifying a number of buffers required to reorganize the one UOW (406). For instance, the reorganization module 108 identifies one UOW that uses the highest number of CIs in the overflow part 222 and identifies the number of buffers 107 required to reorganize the one UOW. The reorganization module 108 uses the space maps 226 and counts the CIs in the overflow part 222 in use by the UOWs to determine the UOW that uses the highest number of CIs.

Process 400 includes setting selection criteria based on the number of buffers (408). For example, the reorganization module 108 sets the selection criteria based on the number of buffers 107 determined above. The selection criteria may include the number of buffers 107 plus an additional margin (e.g., an additional 10%).

Process 400 includes reorganizing the area of the database using the selection criteria including bypassing UOWs from the plurality of UOWs that do not meet the selection criteria (410). For example, the reorganization module 108 reorganizes the DEDB area 205 using the selection criteria including bypassing the UOWs that do not meet the selection criteria. In some implementations, the selection criteria include a keyword command to bypass the UOWs that exceed the threshold value for the overflow part 222. The keyword command may be inserted into a reorganization process without manual intervention for reorganizing the DEDB area 205. In some implementations, the largest value allowed as part of the selection criteria may be 32,768.

For instance, in one example, a largest UOW in an area being reorganized may include 36,000 CIs in overflow part 222, and the next largest UOW in the area uses 8,000 CIs in overflow part 222. In this case, the selection criteria may be a keyword command with an amount allocated for buffers 107 needed to reorganize the area set to 8,800 CIs, which is 8,000 plus 10%. Any UOW having greater than 8,800 CIs in the overflow part 222 is bypassed. In this case, the UOW having 36,000 overflow part CIs is bypassed and not included in the reorganization process, and the reorganization process runs to completion without failing.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer-implemented method for reorganizing an area of a database, the computer-implemented method comprising:
traversing space maps of control intervals (CIs) for an overflow part of the area of the database;
for each unit of work (UOW) from a plurality of UOWs stored in the area of the database, determining which of the CIs are allocated to each of the plurality of UOWs from the space maps;
identifying one UOW from the plurality of UOWs that uses a highest number of the CIs in the overflow part and determining a number of buffers required to reorganize the one UOW;
setting selection criteria based on the number of buffers; and
reorganizing the area of the database using the selection criteria including bypassing UOWs from the plurality of UOWs that do not meet the selection criteria.

2. The computer-implemented method of claim 1, wherein the database includes a Fast Path database and the area includes a portion of the Fast Path database.

3. The computer-implemented method of claim 1, wherein the database includes a data entry database (DEDB) and the area includes a DEDB area.

4. The computer-implemented method of claim 1, wherein the selection criteria include a keyword command to bypass the UOWs from the plurality of UOWs that exceed a threshold value of CIs for the overflow part.

5. The computer-implemented method of claim 4, wherein setting the selection criteria includes inserting the keyword command without manual intervention into a reorganization function for reorganizing the area of the database.

6. The computer-implemented method of claim 1, wherein identifying the one UOW from the plurality of UOWs that uses the highest number of the CIs in the overflow part includes, for each UOW, counting the CIs in the overflow part in use by the one UOW.

7. The computer-implemented method of claim 1, wherein traversing the space maps includes traversing the space maps for the overflow part of the area without reading the area in its entirety.

8. A computer program product for reorganizing an area of a database, the computer program product being tangibly embodied on a non-transitory computer-readable medium and including executable code that, when executed, is configured to cause at least one computing device to:
determine an amount of space allocated to units of work (UOWs) in an overflow part of the area of the database;
determine a number of buffers required to reorganize the UOWs;
set selection criteria based on the number of buffers; and
reorganize the area of the database using the selection criteria including bypassing the UOWs that do not meet the selection criteria.

9. The computer program product of claim 8, wherein the executable code is configured to cause the at least one computing device to determine the amount of space allocated to the UOWs in the overflow part by traversing space maps for the overflow part of the area of the database.

10. The computer program product of claim 9, wherein the executable code is configured to cause the at least one computing device to traverse the space maps by traversing the space maps for the overflow part of the area without reading the area in its entirety.

11. The computer program product of claim 8, wherein the database includes a Fast Path database and the area includes a portion of the Fast Path database.

12. The computer program product of claim 8, wherein the database includes a data entry database (DEDB) and the area includes a DEDB area.

13. The computer program product of claim 8, wherein the selection criteria include a keyword command to bypass the UOWs that exceed a threshold value for the overflow part.

14. The computer program product of claim 13, wherein the executable code is configured to cause the at least one computing device to set the selection criteria by inserting the keyword command without manual intervention into a reorganization function for reorganizing the area of the database.

15. A system comprising:
a storage device having stored therein a database;
a database management system communicatively coupled to the storage device;
a reorganization module communicatively coupled to the storage device and the database management system;
at least one processor; and
a memory storing instructions that, when executed by the at least one processor, cause the reorganization module to:
determine an amount of space allocated to units of work (UOWs) in an overflow part of an area of the database;
determine a number of buffers required to reorganize the UOWs;
set selection criteria based on the number of buffers; and
reorganize the area of the database using the selection criteria including bypassing the UOWs that do not meet the selection criteria.

16. The system of claim 15, wherein the reorganization module is configured to determine the amount of space allocated to the UOWs in the overflow part by traversing space maps for the overflow part of the area of the database.

17. The system of claim 16, wherein the reorganization module is configured to traverse the space maps by traversing the space maps for the overflow part of the area without reading the area in its entirety.

18. The system of claim 15, wherein the database includes a Fast Path database and the area includes a portion of the Fast Path database.

19. The system of claim 15, wherein the database includes a data entry database (DEDB) and the area includes a DEDB area.

20. The system of claim 15, wherein the selection criteria include a keyword command to bypass the UOWs that exceed a threshold value for the overflow part.

21. The system of claim 20, wherein the reorganization module is configured to set the selection criteria by inserting the keyword command without manual intervention into a reorganization function for reorganizing the area of the database.
